(19) United States
(12) Patent Application Publication
(10) Pub. No.: US 2016/0091612 A1
(43) Pub. Date: Mar. 31, 2016

(54) METHOD FOR DISPLAYING A POSITION OF A VEHICLE

(71) Applicant: HYUNDAI MOBIS CO., LTD., Seoul (KR)

(72) Inventors: Yu Kang HEO, Yongin-si (KR); Jong In JUNG, Yongin-si (KR)

(21) Appl. No.: 14/807,744

(22) Filed: Jul. 23, 2015

(30) Foreign Application Priority Data
Sep. 30, 2014 (KR) 10-2014-0130963

(51) Int. Cl. G01S 19/51; G01C 21/36

(52) U.S. Cl. CPC G01S 19/51; G01C 21/3667

(57) ABSTRACT

A method for displaying positions of vehicles, may include receiving, by a control unit, position information of a first vehicle via a Global Navigation Satellite System (GNSS) receiving unit; when the position information of the first vehicle is normally received, judging whether there is a second vehicle in a reference distance from the first vehicle via the V2X module; when there is a second vehicle in the reference distance from the first vehicle, collecting vehicle information relating to the second vehicle via the V2X module; and displaying the positions of the first vehicle and the second vehicle to an output unit based on the position information of the first vehicle and the vehicle information relating the second vehicle.

### CROSS-REFERENCES TO RELATED APPLICATIONS

The present application claims priority to Korean application number 10-2014-0130963, filed on Sep. 30, 2014, which is incorporated by reference in its entirety.

### BACKGROUND

1. Field

The present invention relates to a method for displaying a position of a vehicle.

2. Discussion of Related Technology

A Global Navigation Satellite System (GNSS) is a system for providing information relating to a position, altitude, speed, etc. of an object on an earth surface using the satellites revolving on the space orbit.

The GNSS can identify the precise position information to the resolution of up to 1 m or less, and has wide applications in a civil use such as guiding the position of the transportation means such as an airline, ship, and vehicle, etc., measuring topography, urgency rescue, and communication, etc., as well as the military purposes.

The GNSS comprises GNSS receiver for receiving signals from one or more GNSS satellites and a monitoring station on a land surface, and can receive at the GNSS receiver the signals sent by the GNSS satellites to determine its position from the distances from the GNSS satellites.

In the GNSS which is currently used, the Global Positioning System (GPS) for the military purposes made to accurately measure a position of a certain object by U.S. Department of Defense in the early 1970s has been widely used exclusively, and in response GLONASS in Russia, Galileo in European Union, etc. have been developed.

The related technology is disclosed in Korean Patent Laid-open Publication No. 10-2011-0080677 published on Jul. 13, 2011 and entitled “System for predicting a position of a vehicle according to the poor reception of GPS and method for predicting a position of a vehicle using the same”.

### SUMMARY

Embodiments of the present invention are directed to a method for displaying a position of a vehicle which can more accurately display positions of an own vehicle and other vehicles by calculating relative distances between the own vehicle and the other vehicles by sharing GNSS information of the own vehicle and GNSS information of the other vehicles via V2X communication.

In one embodiment, a method for displaying positions of vehicles may include receiving, by a control unit, position information of a first vehicle via a Global Navigation Satellite System (GNSS) receiving unit; when the position information of the first vehicle is normally received, judging whether there is a second vehicle in a reference distance from the first vehicle via the V2X module; when there is a second vehicle in the reference distance from the first vehicle, collecting vehicle information relating to the second vehicle via the V2X module; and displaying the positions of the first vehicle and the second vehicle to an output unit based on the position information of the first vehicle and the vehicle information relating the second vehicle.

In another embodiment, the control unit judges that the position information of the first vehicle is normally received, when the intensity of the position information of the first vehicle received is above a reference intensity and a position change amount per a unit time based on the position information of the first vehicle received is below the reference change amount in receiving the position information of the first vehicle.

In another embodiment, the control unit displays the position of the first vehicle based on the position of the first vehicle which is most recently stored in a memory unit and travel information of the first vehicle, when the position information of the first vehicle is not normally received in receiving the position information of the first vehicle.

In another embodiment, the control unit displays the position of the first vehicle based on the position information of the first vehicle received, when there is no second vehicle in the reference distance in judging whether there is a second vehicle in the reference distance from the first vehicle.

In another embodiment, the control unit collects the vehicle information comprising at least one of identification information, travel information and GNSS information of the second vehicle in collecting the vehicle information relating to the second vehicle.

In another embodiment, the displaying the positions of the first vehicle and the second vehicle to the output unit may comprise generating, by the control unit, a list of the second vehicles based on the information of the second vehicle collected; selecting a third vehicle to calculate a relative distance with the first vehicle among the second vehicles contained in the list of the second vehicles based on a predetermined reference; calculating the relative distance between the first vehicle and the third vehicle based on the position information of the first vehicle and the vehicle information relating to the third vehicle; and displaying the positions of the first vehicle and the third vehicle to the output unit based on the relative distance between the first vehicle and the third vehicle.

In another embodiment, the method may further include, by the control unit, calculating a horizontal component and a vertical component of the relative distance relative to the travel direction of the first vehicle, after calculating the relative distance between the first vehicle and the third vehicle.

In another embodiment, the control unit calculates the horizontal component and the vertical component of the relative distance based on the position information, direction information, and relative distance of the first vehicle and the third vehicle in calculating the horizontal component and the vertical component of the relative distance.

In another embodiment, the control unit selects as the third vehicle a vehicle having a high risk of collision with the first vehicle in selecting the third vehicle to calculate the relative distance with the first vehicle.

In another embodiment, the control unit judges the risk of collision based on at least one of the relative position, relative speed and travel direction between the first vehicle and the second vehicle.

### BRIEF DESCRIPTION OF THE DRAWINGS

FIG. 1 is a functional block diagram of an apparatus for implementing a method for displaying a position of a vehicle according to an embodiment of the present invention.

FIG. 2 is a diagram illustrating an example for calculating a horizontal component and a vertical component of a relative distance according to the method for displaying the position of the vehicle according to an embodiment of the present invention.

FIG. 3 is a flow chart illustrating a procedure for implementing the method for displaying the position of the vehicle according to an embodiment of the present invention.

### DESCRIPTION OF EMBODIMENTS

Embodiments of the invention will hereinafter be described in detail with reference to the accompanying drawings. It should be noted that the drawings are not to precise scale and may be exaggerated in thickness of lines or sizes of components for descriptive convenience and clarity only.

Furthermore, the terms as used herein are defined by taking functions of the invention into account and can be changed according to the custom or intention of users or operators. Therefore, definition of the terms should be made according to the overall disclosures set forth herein.

A vehicle may display, on its display, positions of other vehicles positioned at the vicinity of the own vehicle as well as the position of the vehicle.

To display positions of the own vehicle and surrounding vehicles together, it is important to more accurately determine relative positions between respective vehicles, and to this end, the technologies for determining accurately the positions of the vehicles by reflecting movement of the vehicles or by DGPS (Differential GPS) technology, etc. may be used.

However, such technologies have the disadvantages that the number of factors to be additionally analyzed is increased, and in cases of using DGPS the DGPS may be implemented in a situation where two independent GPS receivers are provided and communication between the receivers can be performed, and various variables for calculating data and thus complex calculating procedures are required.

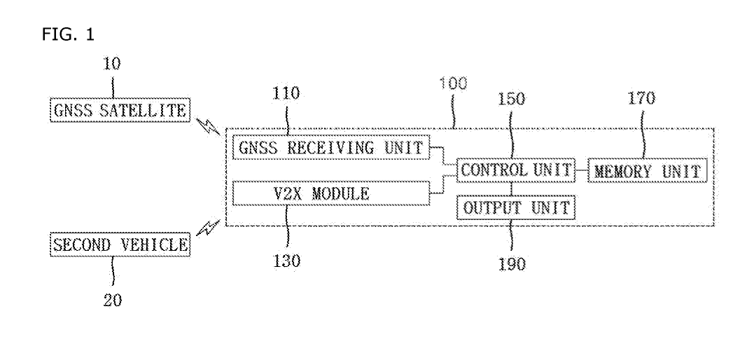

FIG. 1 is a functional block diagram of an apparatus for implementing a method for displaying a position of a vehicle according to an embodiment of the present invention.

Referring to FIG. 1, an apparatus for implementing a method for displaying a position of a vehicle according to an embodiment of the present invention may comprise a GNSS (Global Navigation Satellite System) receiving unit 110, a V2X (Vehicle To Vehicle and Vehicle To Infrastructure) module 130, a control unit 150, a memory unit 170 and an output unit 190.

The GNSS receiving unit 110 is an apparatus for receiving the position information of the vehicle in which the GNSS receiving unit 110 is mounted, from GNSS satellites 10, and comprises all the elements for receiving the position information, comprising a GPS receiving unit or a GLONASS receiving unit, etc.

In particular, the technologies for obtaining the position information of the vehicle in which the GNSS receiving unit 110 is mounted, by transmitting or receiving signals between the GNSS satellites 10, a ground control part and the GNSS receiving unit 110, has been already known in the art and thus the detail description on this will been omitted.

The V2X module 130 is an element for transmitting or receiving vehicle information to or from the vehicles in the vicinity of the own vehicle, i.e. a vehicle which becomes an object where positions of vehicles are intended to be displayed via the communication between them.

That is, in the present embodiment, to display positions of the surrounding vehicles as well as the own vehicle together via the communication with the surrounding vehicles, the own vehicle may transmit or receive the vehicle information to or from the surrounding vehicles via the V2X module 130.

In the following, the own vehicle which becomes an object where positions of vehicles are intended to be displayed may be referred as to a first vehicle, and the surrounding vehicles which is positioned in a reference distance from the first vehicle may be referred as to a second vehicle.

Here, the second vehicle may comprise all the elements for implementing a method for displaying a position of a vehicle described below like the first vehicle and thus display the own vehicle and the surrounding vehicles as is the first vehicle.

In particular, in the present embodiment, the V2X module 130 may collect the vehicle information comprising at least one of identification information, travel information and GNSS information of the second vehicle 20.

Wherein, the identification information refers to the ID (IDentification) information which can identify a vehicle such as a vehicle identification number of a vehicle, and the travel information refers to the travel-relevant information relating to a speed, acceleration or steering angle, etc. of the vehicle.

The technologies for transmitting or receiving information between the vehicles via the V2X module 130 can comprise widely known Wave scheme, and all the communication schemes such as 3G, 4G, etc. via which the communication between the vehicles can be performed may be used.

The control unit 150 may display the positions of the first vehicle and the second vehicles to the output unit 190 based on the position information of the first vehicle or the position information of the second vehicle.

In particular, the control unit 150 may determine the positions of the vehicles differently in a different manner based on whether the position information of the first vehicle is normally received via the GNSS receiving unit 110 and whether there is the second vehicle in a reference distance from the first vehicle.

Here, the reference distance refers to a distance between the vehicles at which transmitting or receiving information between the V2X modules 130 can be performed correctly, and depends on characteristics, etc. of the V2X module 130.

Like this, the control unit 150 may display the positions of the vehicles in a three different manner based on whether the position information of the first vehicle is normally received, and whether there is a second vehicle in the reference distance from the first vehicle.

The control unit 150 may determine and display the positions of the vehicles in a three different manner, firstly, when the position information of the first vehicle is normally received and there is a second vehicle 20 in the reference distance from first vehicle, secondly, when the position information of the first vehicle is normally received and there is no second vehicle 20 in the reference distance from the first vehicle, and thirdly, when the position information of the first vehicle is not normally received.

In particularly, first of all, the control unit 150 may judge whether the intensity of the position information received of the first vehicle is above a reference intensity, in connection with whether the position information of the first vehicle is normally received via the GNSS receiving unit 110.

Here, the reference intensity refers to the intensity of information enough to recognize that the information is correctly contained based on its strength, and depends on the characteristic, etc. of the GNSS receiving unit 110.

Accordingly, when the position information of the first vehicle received via GNSS receiving unit 110 is below the reference intensity, the control unit 150 may not take this information into consideration as the reliability on the information contained in this position information is low.

Furthermore, the control unit 150 may judge whether the position information of the first vehicle is normally received by judging whether the position change amount of the first vehicle per a unit time based on the position information received of the first vehicle is below the reference change amount.

Here, the reference change amount refers to the position change amount of the vehicle, i.e., the speed of the vehicle capable of being generated when the vehicle is being normally travelled, and depends on the characteristics, etc. of the vehicle.

For example, when the control unit receives the position information of the first vehicle per a unit time (1 sec) and then the position change amount of the first vehicle based on this time period is 100 m, as the speed of the first vehicle is considered to be 100 m/s, the control unit may judge that the position information received is in error.

Accordingly, if the position change amount of the first vehicle per a unit time based on the position information of the first vehicle received periodically is above the reference change amount, the control unit 150 may not take this position information into consideration.

However, as the present embodiment is not restricted thereto, the control unit may judge whether the position information of the first vehicle is normally received via any other manner which is not mentioned herein.

In the following, the specific procedure will be now described that the control unit 150 according to the present embodiment displays the positions of the vehicles based on whether the position information of the first vehicle is normally received and whether there is a second vehicle in the reference distance from the first vehicle.

Firstly, when the position information of the first vehicle is normally received and there is a second vehicle in the reference distance from the first vehicle, the control unit 150 may display the positions of the first vehicle and the second vehicles to the output unit 190 based on the position information of the first vehicle received via the GNSS receiving unit 110 and the vehicle information relating to the second vehicle.

More specifically, the control unit 150 may firstly generate a list of the second vehicles based on the information of the second vehicles collected via the V2X module 130. That is, the list of the second vehicles is a list of the second vehicle (which may also be called a second vehicle list) in the reference distance from the first vehicle.

And, the control unit 150 may select a third vehicle to calculate a relative distance with the first vehicle among the second vehicles contained in the second vehicle list. That is, as mentioned above, as the reference distance refers to a distance between the vehicles at which the communication between the V2X modules 130 can be performed, some second vehicle which cannot affect the travel of the first vehicle may be in the second vehicle list.

Accordingly, the control unit 150 may select as the third vehicle a vehicle having a high risk of collision with the first vehicle among the second vehicles.

That is, in the present embodiment, the own vehicle which becomes an object where positions of vehicles are intended to be displayed can be referred to as a first vehicle, the vehicles positioned in the reference distance from the first vehicle can be referred to as a second vehicle, and the vehicles having the high risk of collision with the first vehicle among the second vehicles can be referred to as a third vehicle.

More specifically, the control unit 150 may judge the risk of collision based on at least one of the relative position, relative speed and travel direction of the first vehicle and the second vehicle. That is, as the risk of collision of the first vehicle and the second vehicle may be varied based on which vehicle of the first vehicle and the second vehicle is positioned in front of on the travel road, which vehicle has higher speed, or whether the travel directions of vehicles is equal or not, etc., the control unit 150 may select the third vehicle taking this conditions into consideration.

And, the control unit 150 may calculate the relative distance of the first vehicle and the third vehicle based on the position information of the first vehicle and the vehicle information relating to the third vehicle.

As mentioned above, as the vehicle information collected via the V2X module 130 comprises at least one of identification information, travel information and GNSS information of the vehicle, the control unit 150 may calculate the relative distance by comparing a position coordinate of the first vehicle with a position coordinate of the third vehicle.

For example, when the position coordinate of the first vehicle is (x1, y1, z1) and the position coordinate of the third vehicle is (x2, y2, z3), the relative distance between the first vehicle and the third vehicle may be calculated via Equation 1 below.

Dᵣₑₗₐₜᵢᵥₑ=(x₁−x₂)²+(y₁−y₂)²+(z₁−z₂)² [Eq. 1]

Here, as the position coordinate received via GNSS receiving unit 110 is a three-dimensional coordinate, the relative distance may be calculated using the three-dimensional coordinate in the Equation 1. However, as the present embodiment is not restricted thereto, the relative distance may be calculated based on the two-dimensional coordinates (latitude and longitude) of the first vehicle and the third vehicle obtained via respective GNSS information.

More specifically, in the present embodiment, the control unit 150 may calculate the relative distance between the first vehicle and the third vehicle, and then, further calculate a horizontal component and a vertical component of the relative distance relative to the travel direction of the first vehicle.

That is, when the positions of the first vehicle and the third vehicle are mapped onto a map, if the relative distance is known, the position of the third vehicle from the first vehicle (whether the third vehicle is on the same road lane as the first vehicle or a road lane next to the first vehicle, etc.) cannot be displayed specifically accurately.

Accordingly, the control unit 150 may calculate the horizontal component of the relative distance parallel to the travel direction of the first vehicle and the vertical component of the relative distance vertical to the travel direction of the first vehicle based on the position information, direction information and relative distance of the first vehicle and the third vehicle.

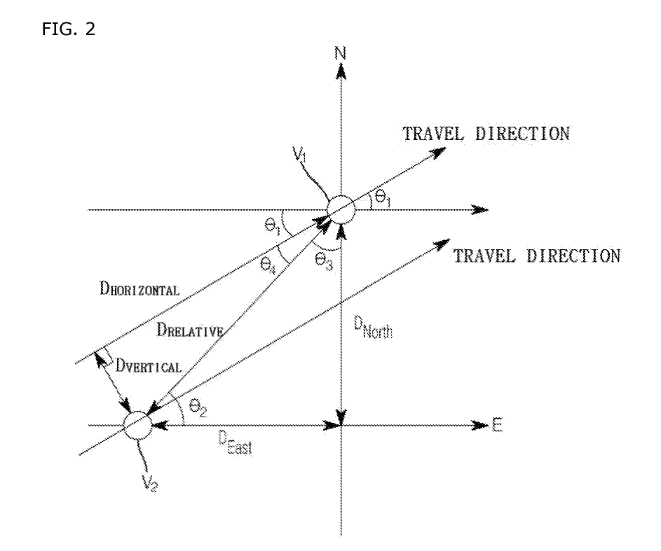

FIG. 2 is a diagram illustrating an example for calculating the horizontal component and the vertical component of the relative distance according to the method for displaying the position of the vehicle according to an embodiment of the present invention.

In the following, for convenience, although an example for calculating the horizontal component and the vertical component of the relative distance of the first vehicle and the third vehicle in a plane, for example, may be described, as the present embodiment is restricted thereto, it will be appreciated that these horizontal and vertical components may be calculated in a space.

Referring to FIG. 2, the control unit 150 may calculate the horizontal component and the vertical component of the relative distance via Equation 2 to 4 below.

S_{East}=x₁−x₂

D_{North}=y₁−y₂ [Eq. 2]

(wherein, (x1, y1) is a coordinate of the first vehicle V1 and (x2, y2) is a coordinate of the third vehicle V2)

$$\begin{matrix}{θ}_{2} = {tan}^{- 1} ( \frac{{D}_{North}}{{D}_{East}} ) \\ {θ}_{3} = 90 - {θ}_{2} \\ {θ}_{4} = 90 - {θ}_{1} - {θ}_{3} & [ Eq . 3 ] \\ {D}_{vertical} = {D}_{relative} \times sin {θ}_{4} \\ {D}_{vertical} = {D}_{relative} \times sin {θ}_{4} {θ}_{4} \\ {D}_{horizontal} = {D}_{relative} \times cos {θ}_{4} & [ Eq . 4 ]\end{matrix}$$

More specifically, the control unit 150 may calculate an East direction distance and a North direction distance of the first vehicle V1 and the third vehicle V2 via the Equation 2, respectively.

And, the control unit 150 may calculate an angle θ2 at which a line connecting the first vehicle V1 to the third vehicle V2 via the Equation 3 meets the East direction, an angle θ3 at which a line connecting the first vehicle V1 to the third vehicle V2 meets the North direction, and an angle θ4 at which a line connecting the first vehicle V1 to the third vehicle V2 meets the travel direction of the first vehicle V1.

Then, the control unit 150 may calculate the horizontal component and the vertical component of the relative distance using the relative distance of the first vehicle V1 and the third vehicle V2 and θ4, respectively.

As the above-mentioned method has been described merely as an example for calculating the horizontal component and the vertical component of the relative distance of the first vehicle and the third vehicle, the present embodiment may calculate the horizontal component and the vertical component of the relative distance by any other manner which is not mentioned herein based on the position information of the first vehicle and the third vehicle, the direction information of the first vehicle and the third vehicle, and the relative distance of the first vehicle and the third vehicle.

Then, the control unit 150 may display the positions of the first vehicle and the third vehicle based on the relative distance calculated, to the output unit 190.

Secondly, when the position information of the first vehicle is normally received and there is no second vehicle in the reference distance from the first vehicle, the control unit 150 may display the position of the first vehicle based on the position information of the first vehicle received via the GNSS receiving unit 110.

That is, when there is no second vehicle in the reference distance from the first vehicle, as there is no vehicle which can affect the first vehicle, the control unit 150 may display the position of the first vehicle based on the position information of the first vehicle received normally.

Thirdly, when the position information of the first vehicle is not normally received, the control unit 150 may display the position of the first vehicle based on the most recent position of the first vehicle and the travel information of the first vehicle.

That is, when the position information of the first vehicle is not normally received via the GNSS receiving unit 110, the first vehicle may be judged to be positioned in a shade region in which GNSS receiving is restricted. At this case GNSS information may be not normally received from the second vehicle in the vicinity of the first vehicle.

Accordingly, the control unit 150 may display the position of the first vehicle only, and specifically determine the position of the first vehicle using the inertia navigation method for reflecting the travel information comprising the speed and direction of the first vehicle based on the position of the first vehicle stored most recently in the memory unit 170.

That is, the control unit may calculate the time difference between the current time and the time in which the position of the first vehicle is most recently stored, calculate the travel distance of the first vehicle by multiplying the time difference by the speed of the first vehicle, and determine the current position of the first vehicle by combining the direction information of the first vehicle.

The memory unit 170 may store the position information of the first vehicle received via the GNSS receiving unit 110, and the vehicle information relating to the second vehicle received via the V2X module 130.

The output unit 190 may display the positions of the first vehicle and the second vehicle under the control of the control unit 150, so that driver can ascertain how many vehicles having a high risk of collision in the vicinity of the first vehicle exist.

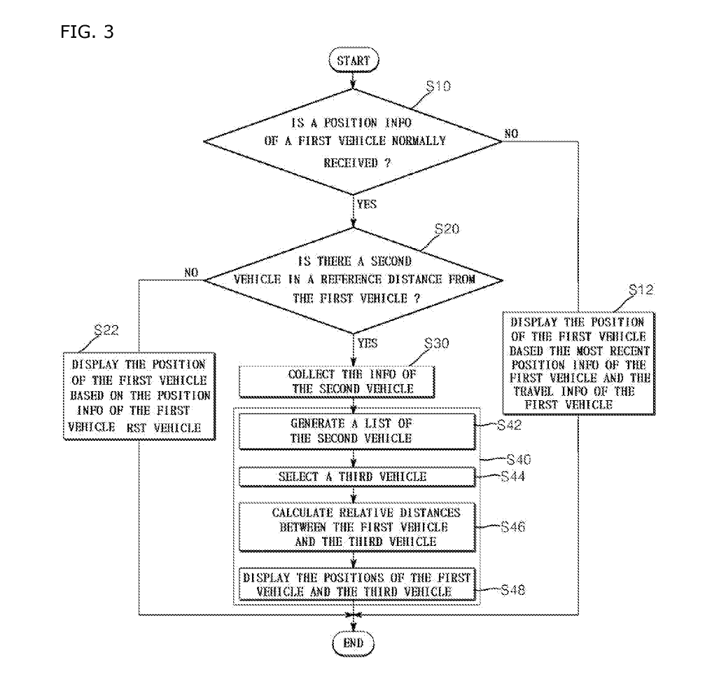

FIG. 3 is a flow chart illustrating a procedure for implementing the method for displaying the position of the vehicle according to an embodiment of the present invention.

Referring to FIG. 3, the method for displaying the position of the vehicle according to an embodiment of the present invention will be described. First of all, the control unit 150 may receive the position information of the first vehicle via the GNSS receiving unit 110, and judge whether the position information of the first vehicle is normally received (S10).

More specifically, the control unit 150 may judge that the position information of the first vehicle is normally received, when the intensity of the position information of the first vehicle received via the GNSS receiving unit 110 is above the reference intensity and the position change amount per a unit time based on the position information of the first vehicle is below the reference change amount.

Here, the reference intensity refers to the intensity of information enough to recognize that the information is correctly contained based on its strength, and depends on the characteristic, etc. of the GNSS receiving unit 110, and the reference change amount refers to the position change amount of the vehicle, i.e., the speed of the vehicle capable of being generated when the vehicle is being normally travelled, and depends on the characteristics, etc. of the vehicle.

That is, when the position information of the first vehicle received via the GNSS receiving unit 110 is below the reference intensity, the control unit 150 may ignore the position information having the intensity lower than the reference intensity as the reliability on the information contained in this position information is low.

Also, the position change amount of the first vehicle per a unit time based on the position information of the first vehicle received periodically is above the reference change amount, the control unit 150 may ignore this position information.

Then, the control unit 150 may judge whether there is a second vehicle in the reference distance from the first vehicle via the V2X module 130 (S20).

In the present embodiment, the control unit 150 may judge whether there is a second vehicle in the reference distance from the first vehicle, so as to display together the positions of the first vehicle corresponding to the own vehicle and second vehicles in the vicinity of the own vehicle.

As a result of judging, when there is a second vehicle in the reference distance from the first vehicle, the control unit 150 may display the positions of the first vehicle and second vehicle to the output unit 190 based on the position information of the first vehicle received via the GNSS receiving unit 110 and the vehicle information relating to the second vehicle collected via the V2X module 130 (S40).

More specifically, the control unit 150 may generate first of all a list of the second vehicle based on the information relating to the second vehicle collected via the V2X module 130 (S42). That is, the list of the second vehicle is a list of all the second vehicles (which may also be called a second vehicle list) in the reference distance from the first vehicle.

And, the control unit 150 may select a third vehicle to calculate the relative distance with the first vehicle among the second vehicles contained in the second vehicle list (S44). That is, as mentioned above, as the reference distance is a distance between the vehicles at which communication between the V2X modules 130 can be performed, there may be a second vehicle which cannot really affect the travel of the first vehicle.

Accordingly, the control unit 150 may select as a third vehicle a vehicle having a high risk of collision with the first vehicle among the second vehicles.

More specifically, the control unit 150 may judge the risk of collision based on at least one of relative position, relative speed and travel direction of the first vehicle and the second vehicles.

Then, the control unit 150 may calculate the relative distance of the first vehicle and the third vehicle based on the position information of the first vehicle and the vehicle information of the third vehicle (S46).

As mentioned above, as the vehicle information collected via the V2X module 130 comprises at least one of the identification information, travel information and GNSS information of the vehicle, the control unit 150 may calculate the relative distance by comparing the position coordinate of the first vehicle with the position coordinate of the third vehicle.

More specifically, in the present embodiment, the control unit 150 may calculate the relative distance of the first vehicle and the third vehicle, and then further calculate the horizontal component and the vertical component of the relative distance relative to the travel direction of the first vehicle.

That is, when the positions of the first vehicle and the third vehicle are mapped onto the map, if there is the relative distance only, the position of the third vehicle from the first vehicle cannot be specifically accurately displayed.

Accordingly, the control unit 150 may calculate the horizontal component of the relative distance parallel to the travel direction of the first vehicle, and the vertical component of the relative distance vertical to the travel direction the first vehicle.

And, the control unit 150 may display the positions of the first vehicle and the third vehicle to the output unit 190 based on the relative distance calculated (S48).

On the other hand, when the position information of the first vehicle is not normally received in the above-mentioned step (S10), the control unit 150 may display the position of the first vehicle based on the most recent position of the first vehicle and the travel information of the first vehicle (S12).

That is, when the position information of the first vehicle is not normally received via the GNSS receiving unit 110, the control unit may judge that the first vehicle is positioned in a shade region in which the GNSS receiving is restricted. At this case, the GNSS information is not normally received from the second vehicle in the vicinity of the first vehicle.

Accordingly, the control unit 150 may display the position of the first vehicle only, and specifically determine the position of the first vehicle by reflecting the travel information comprising the speed and direction of the first vehicle based on the position of the first vehicle which is most recently stored in the memory unit 170.

On the other hand, when it is judged that the position information of the first vehicle is normally received and there is no second vehicle in the reference distance from the first vehicle in the above-mentioned step (S20), the control unit 150 may display the position of the first vehicle based on the position information of the first vehicle received via the GNSS receiving unit 110 (S22).

That is, when there is no second vehicle in the reference distance from the first vehicle, as there is no vehicle which can affect the first vehicle, the control unit 150 may display the position of the first vehicle based on the position information of the first vehicle which is normally received.

According to the present embodiment, the control unit may display more accurately the positions of an own vehicle and other vehicles by calculating the relative distances of the own vehicle and the other vehicles by sharing the GNSS information of the own vehicle and the GNSS information of the other vehicles via the V2X communication.

Also, embodiments of the present invention can help a safe driving of a driver by selecting surrounding vehicles only which can affect the travel of the own vehicle and by displaying together the own vehicle and the surrounding vehicles.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A method for displaying positions of vehicles, comprising:
receiving, by a control unit, position information of a first vehicle via a Global Navigation Satellite System (GNSS) receiving unit;
when the position information of the first vehicle is normally received, judging whether there is a second vehicle in a reference distance from the first vehicle via a V2X module;
when there is a second vehicle in the reference distance from the first vehicle, collecting vehicle information relating to the second vehicle via the V2X module; and
displaying the positions of the first vehicle and the second vehicle to an output unit based on the position information of the first vehicle and the vehicle information relating the second vehicle.

2. The method according to claim 1, wherein the control unit judges that the position information of the first vehicle is normally received, when the intensity of the position information of the first vehicle received is above a reference intensity and a position change amount per a unit time based on the position information of the first vehicle received is below the reference change amount in receiving the position information of the first vehicle.

3. The method according to claim 1, wherein the control unit displays the position of the first vehicle based on the position of the first vehicle which is most recently stored in a memory unit and a travel information of the first vehicle, when the position information of the first vehicle is not normally received in receiving the position information of the first vehicle.

4. The method according to claim 1, wherein the control unit displays the position of the first vehicle based on the position information of the first vehicle received, when there is no the second vehicle in the reference distance in judging whether there is the second vehicle in the reference distance from the first vehicle.

5. The method according to claim 1, wherein the control unit collects the vehicle information comprising at least one of identification information, travel information and GNSS information of the second vehicle in collecting the vehicle information relating to the second vehicle.

6. The method according to claim 5, wherein displaying the positions of the first vehicle and the second vehicle to the output unit comprises:
generating, by the control unit, a list of the second vehicles based on the information of the second vehicle collected;
selecting a third vehicle to calculate a relative distance with the first vehicle among the second vehicles contained in the list of the second vehicles based on a predetermined reference;
calculating the relative distance between the first vehicle and the third vehicle based on the position information of the first vehicle and the vehicle information relating to the third vehicle; and
displaying the positions of the first vehicle and the third vehicle to the output unit based on the relative distance between the first vehicle and the third vehicle.

7. The method according to claim 6, further comprising, by the control unit, calculating a horizontal component and a vertical component of the relative distance relative to the travel direction of the first vehicle, after calculating the relative distance between the first vehicle and the third vehicle.

8. The method according to claim 7, wherein the control unit calculates the horizontal component and the vertical component of the relative distance based on the position information, direction information, and relative distance of the first vehicle and the third vehicle in calculating the horizontal component and the vertical component of the relative distance.

9. The method according to claim 6, wherein the control unit selects as the third vehicle a vehicle having a high risk of collision with the first vehicle in selecting the third vehicle to calculate the relative distance with the first vehicle.

10. The method according to claim 9, the control unit judges the risk of collision based on at least one of the relative position, relative speed and travel direction between the first vehicle and the second vehicle.
